(19) United States
(12) Patent Application Publication
(10) Pub. No.: US 2024/0184127 A1
(43) Pub. Date: Jun. 6, 2024

(54) APPARATUSES AND METHODS INVOLVING WAVEPLATES WITH ARBITRARY/CHOSEN POLARIZATION AXIS

(71) Applicant: The Board of Trustees of the Leland Stanford Junior University, Stanford, CA (US)

(72) Inventors: Jonathan Fan, Los Altos, CA (US); Thaibao Phan, Redwood City, CA (US); Evan Wang, Stanford, CA (US)

(21) Appl. No.: 18/285,485

(22) PCT Filed: Apr. 4, 2022
(86) PCT No.: PCT/US2022/023267

§ 371 Date: Oct. 3, 2023

Related U.S. Application Data
(60) Provisional application No. 63/172,548, filed on Apr. 8, 2021.

(51) Int. Cl. G02B 27/10; G02B 26/06; G02B 27/28

(52) U.S. Cl. CPC G02B 27/1086; G02B 26/06; G02B 27/1006; G02B 27/286

(57) ABSTRACT

In certain examples, aspects are directed to using a first beamsplitter and a second beamsplitter arranged with respect to one another with the first beamsplitter splitting incident light into multiple light beams, along a particular polarization basis, and with the second beamsplitter recombining and interfering with the multiple light beams to provide a recombined light beam characterized as having at least one of the following attributes: mapping between a polarization state and different wavelengths of the incident light; and a polarization tuning of the incident light.

### BACKGROUND

Aspects of the present disclosure are related generally to the field of light manipulation and optical devices and systems.

Polarization manipulation across multiple wavelengths is a critical task for many applications such as ellipsometry or pulsed laser systems. However, there does not exist a method for dynamically tuning the polarization state of light across a large bandwidth. Current polarization solutions experience various dispersion effects such that the same polarization state at different wavelengths will map to different final polarization states. Such dispersion affects and restricts the usefulness of polarization optics to single wavelength operation, or requires that multiple wavelengths be scanned sequentially with the system being recalibrated between each such scan. Additionally, these solutions largely operate in the linear polarization basis, limiting the available polarization operations that can be performed. In contrast, arbitrary polarization axes allow for full manipulation of the polarization space.

These and other matters have presented challenges for a variety of applications.

### SUMMARY OF VARIOUS ASPECTS AND EXAMPLES

Various examples/embodiments presented by the present disclosure are directed to issues such as those addressed above and/or others which may become apparent from the following disclosure. Certain example aspects of the present disclosure are directed to methods and/or apparatuses (e.g., systems, devices, waveplates, etc.) that use, leverage from and/or involve polarization manipulation involving use of optical elements to map different wavelengths (e.g., within a defined bandwidth) to a common polarization state and/or setting or tuning (e.g., dynamically) polarization state(s) of light across such a bandwidth. In more specific examples, the optical elements may be waveplates such as the type that integrate selected gratings (e.g., as may be implemented in one or more grating layers integrated as a single waveplate), and in certain applications the setting or tuning may be realized dynamically such as by moving one waveplate relative to the other waveplate and thereby causing a split light beam, between two such waveplates, to experience a displacement phase shift.

In certain example embodiments, aspects of the present disclosure involve or are directed to an apparatus and/or a method for tuning the polarization state of light achromatically and along arbitrary polarization axes. In more particular examples, devices that may be tuned as such would be extremely advantageous in a wide range of applications including commercial polarization instrumentation, experimental research, industrial machinery, etc.

In yet other related examples, aspects of the present disclosure are directed to an apparatus (e.g., one of two beamsplitters) and its use in an optical system having another beamsplitter acting to split incident light into multiple light beams along a particular polarization basis or to recombine the split light beams, and wherein the first and second beamsplitters are to be coupled and arranged relative to one another such that the incident light beam at one of the beamsplitters is split and then recombined by the other of the beamsplitters to provide a recombined light beam characterized as having at least one of the following attributes: a polarization state which maps to different wavelengths of the incident light; and a polarization tuning of the incident light.

Certain other examples according to the present disclosure may also build on the above-discussed aspects and embodiments. The following exemplifies such examples: the multiple wavelengths may be selected from within a light-spectrum wavelength band that is greater than 50 nanometers and less than or equal to 200 nanometers; and the polarization state may be set through polarization tuning of the incident light, and the polarization tuning may include at least one of: adjusting a displacement of the first beamsplitter relative to the second beamsplitter along a plane that is transverse to a direction of the incident light; and changing a grating effect provided by at least one of the first beamsplitter and the second beamsplitter. Further, the first beamsplitter and the second beamsplitter may be constructed to correspond to each other (e.g., oriented in parallel and/or constructed with the same materials), and the particular polarization basis may correspond to at least one set of orthogonal polarizations at equal and opposite angles, appreciating that orthogonal polarizations includes pairs of elliptical or circular polarizations that do not have well defined “angles”. In yet further such examples: at least one of the first and second beamsplitters may be mounted on a stage for travelling in the optical plane orthogonal to the beamline, and as the first and second beamsplitters are displaced relative to each other, the two split beams experience a displacement phase shift; and in a further specific example, at least one of the first beamsplitter and the second beamsplitter includes a waveplate including a grating material wherein the waveplate is characterized by or includes one or more of the following: being movable along at least one linear direction relative another of the at least one of the first beamsplitter and the second beamsplitter; and being rotatable or spinnable relative another of the at least one of the first beamsplitter and the second beamsplitter, and wherein movement of the grating material is to cause the multiple light beams to experience a displacement phase shift.

The above discussion is not intended to describe each aspect, embodiment or every implementation of the present disclosure. The figures and detailed description that follow also exemplify various embodiments.

### BRIEF DESCRIPTION OF FIGURES

Various example embodiments, including experimental examples, may be more completely understood in consideration of the following detailed description in connection with the accompanying drawings, each in accordance with the present disclosure, in which:

FIG. 1 is a first example of an optical system and illustrating exemplary waveplates, according to and including certain exemplary aspects of the present disclosure:

FIG. 2 is a second example of an optical system and illustrating exemplary movement or displacement, according to and including certain exemplary aspects of the present disclosure:

FIG. 3A is an illustration of an example grating layer with certain irregular shaped elements, according to certain exemplary aspects of the present disclosure:

FIGS. 3B, 3C, 3D, 3E and 3F are illustrations of exemplary waveplate elements that have one or more irregular and/or freeform shapes, according to certain exemplary aspects of the present disclosure:

FIG. 4 is a diagram illustrating, for certain example systems according to certain exemplary aspects of the present disclosure, a displacement phase for the −2, −1, 0, +1, and +2 diffraction orders:

FIG. 5 is a third example of an optical system, according to and including certain exemplary aspects of the present disclosure;

FIG. 6 is an illustration of a Poincare sphere modified with depictions according to certain exemplary aspects of the present disclosure:

FIG. 7 is another example of an optical system, according to and including certain exemplary aspects of the present disclosure:

FIG. 8 is an example of a waveplate for use in an optical system, which shows exemplary moveable (e.g., spinnable and/or rotatable) parts, according to aspects of the present disclosure; and

FIGS. 9A and 9B are plots showing polarization modulation of an experimental sample involving two fabricated polarization gratings (aka gating structures, each of which includes one or more grating layers) functioning as beamsplitting waveplates, according to certain exemplary aspects of the present disclosure.

While various embodiments discussed herein are amenable to modifications and alternative forms, aspects thereof have been shown by way of example in the drawings and will be described in detail. It should be understood, however, that the intention is not to limit the disclosure to the particular embodiments described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION

Certain aspects of the present disclosure are believed to be applicable to a variety of different types of apparatuses, systems and methods directed to or involving uses of optical elements for the manipulation of light, for realizing certain polarization outcomes. While the present disclosure is not necessarily limited to such aspects, an understanding of specific examples in the following description may be understood from discussion in such specific contexts including but not limited to the contexts presented in connection with the figures.

Accordingly, in the following description various specific details are set forth to describe specific examples presented herein. It should be apparent to one skilled in the art, however, that one or more other examples and/or variations of these examples may be practiced without all the specific details given below. In other instances, well known features have not been described in detail so as not to obscure the description of the examples herein. For ease of illustration, the same connotation and/or reference numerals may be used in different diagrams to refer to the same elements or additional instances of the same element. Also, although aspects and features may in some cases be described in individual figures, it will be appreciated that features from one figure or embodiment can be combined with features of another figure or embodiment even though the combination is not explicitly shown or explicitly described as a combination. Further, it would be is appreciated that certain aspects presented herein are described in U.S. Provisional Application Ser. No. 63/172,548 filed on Apr. 8, 2021 (STFD.430P1) with Appendices A, B and C, to which priority is claimed (to the extent permitted, such subject matter is incorporated by reference in its entirety) and that one or various combinations of the structures, optical elements and features disclosed in the Appendices may be modified and/or used in combination with the exemplary aspects disclosed herein.

Exemplary aspects of the present disclosure are believed to be applicable to a variety of different types of apparatuses, systems and methods involving manipulation of light, applicable to multiple wavelengths, for realizing a certain polarization state common to each wavelength. In more specific aspects, the multiple wavelengths may refer to individual wavelengths and/or wavelengths across a band. In more specific examples, realizing such polarization state may involve or include certain polarization tuning achieved, for example, using operations that are manual, automated, dynamic, and wherein the common polarization state is applicable across a wide bandwidth (e.g., significantly greater than 50 nanometers). Further, multiple waveplate modules may be arranged in series to provide manipulation of the incident light beam, wherein one of the multiple waveplate module is a tunable waveplate module that includes the first beamsplitter and the second beamsplitter, and at least one other of the multiple waveplate modules has a polarization basis different from the particular polarization basis of the first beamsplitter.

In other specific examples according to the present disclosure, certain embodiments are directed to methods and systems in which optical processing involves polarization manipulation across multiple wavelengths and/or tuning of the polarization state of light across a large bandwidth such as by setting and/or tuning the polarization state of light achromatically and along arbitrary polarization axes.

In connection with more-specific/experimental aspects of the present disclosure, certain embodiments are directed to a method of using an apparatus or to the apparatus, in which two (identical or otherwise) polarizing beamsplitting elements (aka beamsplitters) are arranged parallel and mirrored relative to one another. The first element may be arranged to split the incident light along a chosen arbitrary polarization basis, with orthogonal polarizations deflected at equal and opposite angles. The second element is set up in reverse to recombine and interfere the two split beams. At least one of the beamsplitting elements is mounted and/or aligned on a stage travelling in the optical plane perpendicular to the beamline. As the beamsplitting elements are moved or displaced relative to each other in one (e.g., z-axis) direction, the two split beams (traveling largely along the x-y axis) will experience a displacement phase shift. In some examples, at least one of the waveplates is configured so that such movement can be easily adjusted to provide dynamic polarization tuning of the incident light.

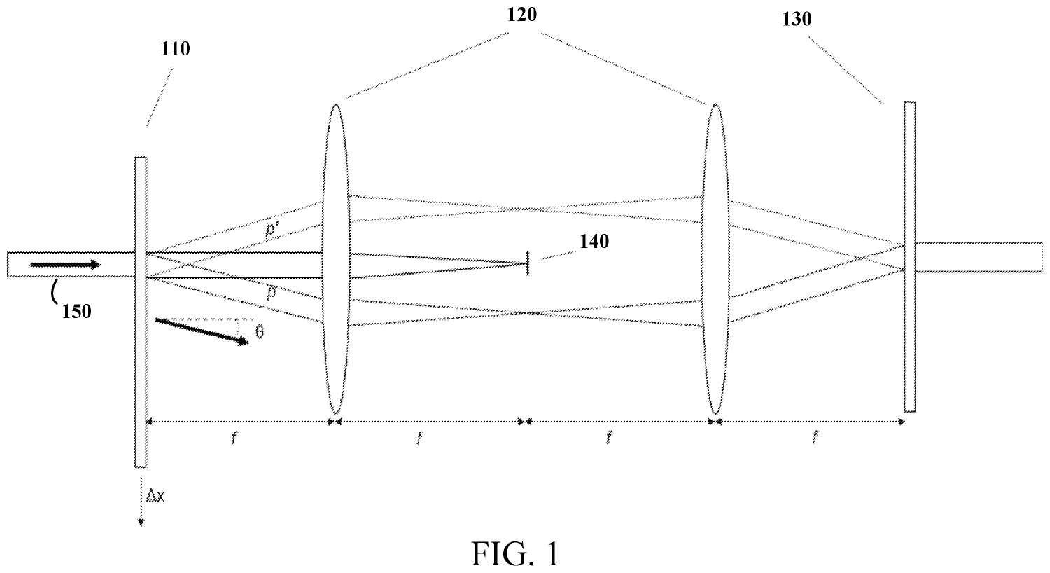

Turning now to the figures, FIG. 1 is a first example of an optical system using a pair of exemplary waveplates 110 and 130 on either side of a 4F optical imaging system 120 according to the present disclosure. In FIG. 1, the two waveplates, at least one of which is moveable relative to the other, may be imaged onto each other via the 4F optical system 120. In one such implementation, the waveplate 110 is movable and the waveplate 130 may remain fixed. The incident light 150 is split into orthogonal polarizations p and p′. Additionally, when using a 4F design as illustrated, a 0-order or higher-order blocker may be added to the system to improve the selectivity by blocking certain attributes of the split light beam. Such a blocker is depicted in FIG. 1 as a 0-order blocker 140 and shown as being an extension of the 4F optical imaging system 120. The configuration illustrated in this example lessens the dependence of overall system performance on the efficiency of the individual beamsplitter elements. For further information regarding 4F technology/systems, reference may be made to the publication at https://ocw.mit.edu/courses/mechanical-engineering/2-71-optics-spring-2009/video-lectures/lecture-19-the-4f-system-binary-amplitude-pupil-masks/MIT2_71S09_lec19.pdf.

In other specific examples, such a 4F optical system may be configured to perform filtering in the Fourier plane to affect a light path between the first beamsplitter and the second beamsplitter by blocking undesired diffraction orders: and for obtaining measurements of light in path between the first beamsplitter and the second beamsplitter. In these examples, filtering may be performed in the Fourier plane, including but not limited to blocking the 0th order, blocking higher undesired (2^{nd} and above) diffraction orders, balancing power in the desired diffraction orders (−1^{st} vs+1^{st}), etc. Such filtering may be used for improving the system performance, selectivity, or other metric, or to introduce new functionality.

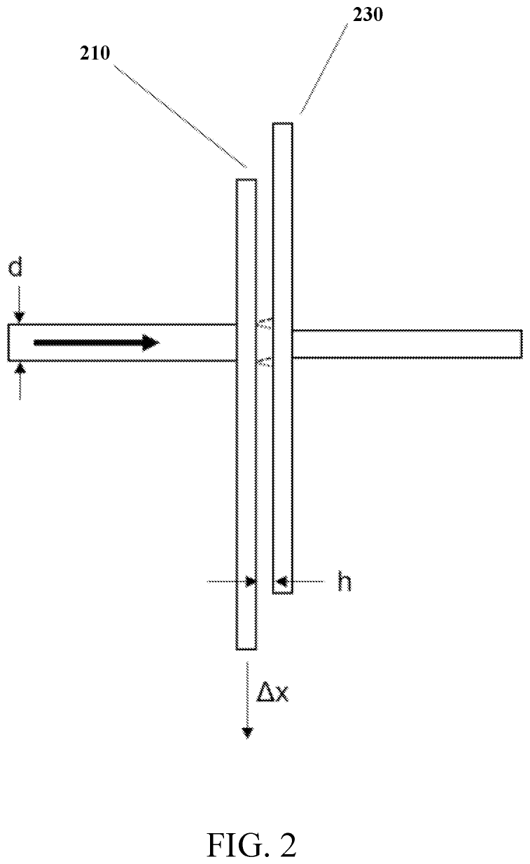

Alternative example embodiments according to the present disclosure do not involve optical processing between such waveplates, as shown in FIG. 2 wherein waveplates 210 and 230 are in close proximity to each other, for example, with the spacing h<d/tan(θ), where d is the beam diameter and θ is the beam deflection angle.

FIG. 2 is also useful for illustrating how two beamsplitters may be moved or displaced relative to each other to effect the above-noted displacement phase shift. Consider, for example, an incident beam at the one beamsplitter forming a split light beam which travels along the x-y axis toward the other beamsplitter. By a very slight movement of one of the beamsplitters relative to the other in the z-axis direction, the (split) light beam will experience a displacement phase shift. In one example, the beamsplitters may be moved or displaced relative to each other by mounting at least one of the beamsplitters so as to be incrementally stepped in macroscopic stages.

The beamsplitter elements may consist of, be based in and/or include gratings of various materials including dielectrics (silicon, glass, polymers), metals (gold, silver), or liquid crystals. These gratings can be designed for a single wavelength or over a wider bandwidth. The overall bandwidth of the system may be directly related to the bandwidth of the individual gratings. The gratings may be designed to operate in a wide range of wavelength regimes, such as ultraviolet, visible, infrared, terahertz and radiofrequencies, and with the system scaled accordingly. Such gratings can rely on geometric phase, propagation phase or other design techniques such as freeform topology optimization.

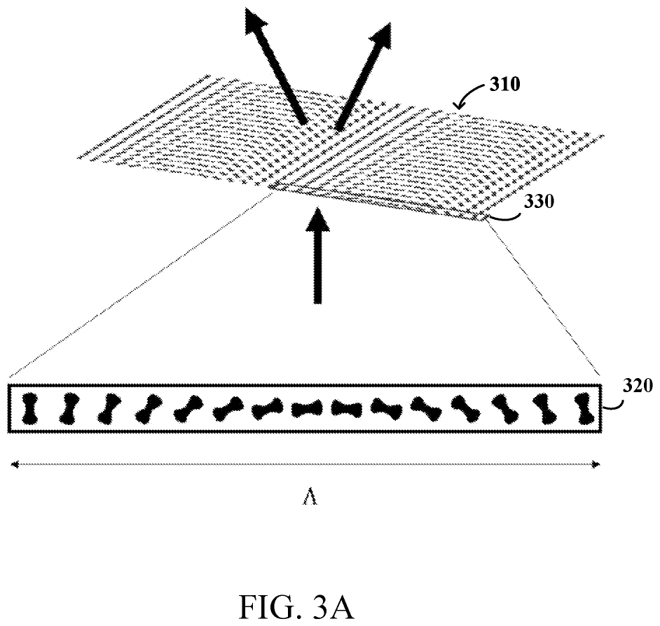

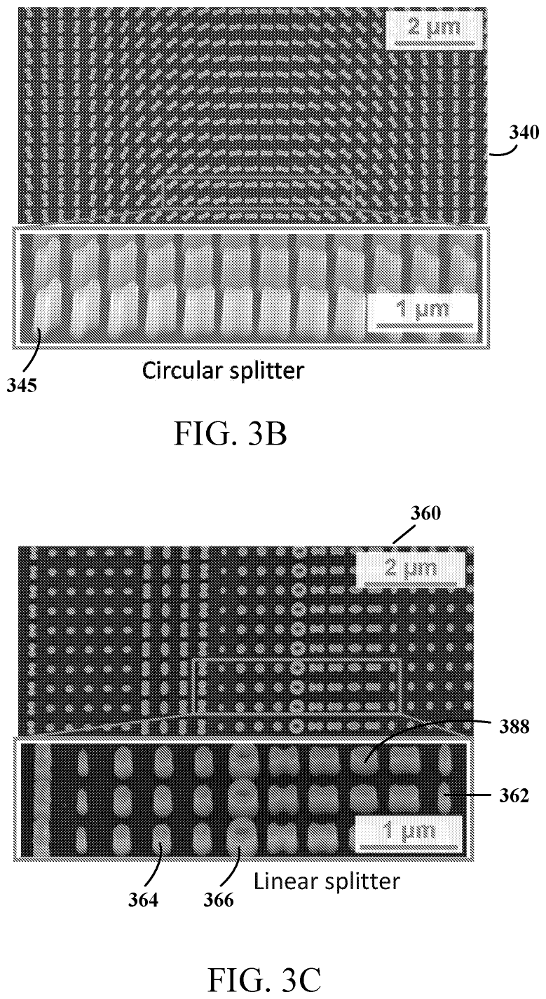

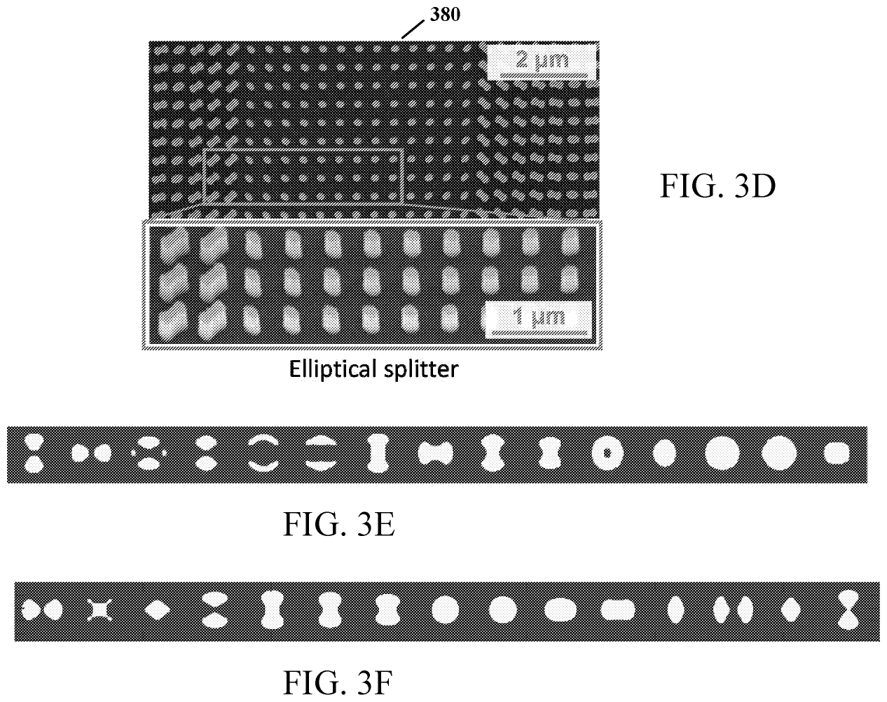

FIGS. 3A-3F are illustrations of examples of different types of beamsplitting elements (e.g., as waveplates) and/or of shapes of microscale devices useful for creating the beamsplitting elements, consistent with the above and other example embodiments, according to the present disclosure. FIG. 3A shows an example freeform geometric phase grating 310 designed to split left-hand and right-hand circularly-polarized light into the −1 and +1 orders, respectively. The inset 320 shows a top down view of a single unit cell 330 of the grating 310, with the grating period A as illustrated across the length of the cell 330.

FIG. 3B illustrates a circular beamsplitter 340 which uses bone-shaped structures 345 which in certain examples may be on the order of one third of micron wide (as shown by the inset) and having a depth or depths (looking into the page) on the order of one micron to a few microns.

FIG. 3C illustrates a linear beamsplitter 360 which uses similarly-sized structures (with some smaller and some larger) including structures that from a top-down perspective are bone-shaped as in FIG. 3B, elongated 362, circular 364, hollow 366 and oval 388.

FIG. 3D illustrates an elliptical beamsplitter 380 which uses differently-shaped structures (also with some smaller and some larger) including structures that are bone-shaped, and elongated, etc. as in FIGS. 3A, 3B and 3C.

FIGS. 3E and 3F respectively illustrate some of the above-exemplified and other examples of shapes (e.g., freeform shapes such as those with one or more narrowed (or widened) center areas, spiked perimeters, and mirrored halves) that may be used individually or in various combinations for such beam splitting. Accordingly, in certain examples, at least one of the first beamsplitter and the second beamsplitter may be characterized by or includes a grating which includes one or more of the following: shaped materials of a free-form design: one or more metals materials: one or more dielectric materials: and a liquid crystal material.

In various examples and without restriction, the widths of such shaped structures may range from one third of a micron to several microns wide, and any one or a combination of such shapes may be used together with positioning of the shaped structures to effect the desired rotation of the light beam during the splitting and/or combining. This is perhaps shown in FIG. 3A, where the bone-shaped structures are shown as being angled to the left of vertical position (zero degrees) as at the far left, and with adjacent bone-shaped structures showing a clockwise rotating transition of the angled position towards vertical position at zero degrees, then incrementally angling to the right of vertical position, and eventually through and past ninety degrees, and to one-hundred-eighty degrees to effect the desired full rotation.

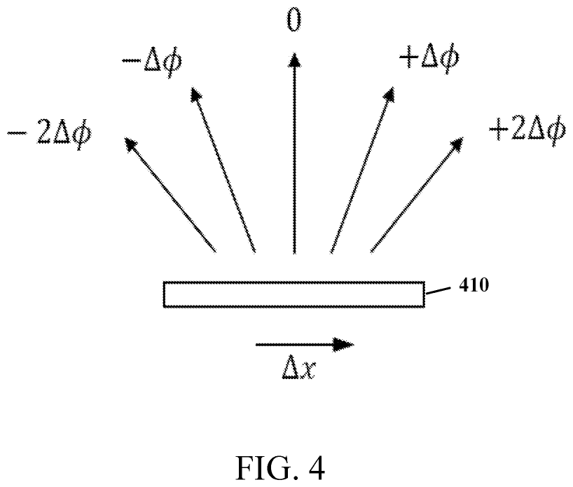

When using gratings as the beamsplitting elements, a relative displacement of Δx between the two gratings leads to a phase difference of Δφ=2nπ/ΔxΛ between the two orthogonal polarization states, where A is the grating period and n is the diffraction order that the polarization state is split into. For an arbitrary waveplate 410, FIG. 4 illustrates the displacement phase for the −2, −1, 0, +1, and +2 diffraction orders. It is noted that the phase difference is independent of wavelength. A basic approach splits the two polarization states into the −1 and +1 diffraction orders such that the total phase difference between the two paths is Δφ=4π/ΔxΛ.

Alternatively, various combinations of higher diffraction orders and/or the zeroth order may be used in order to adjust the desired sensitivity of the device to displacements. The diffraction need not be symmetric, i.e., the +1 and +2 orders may be used.

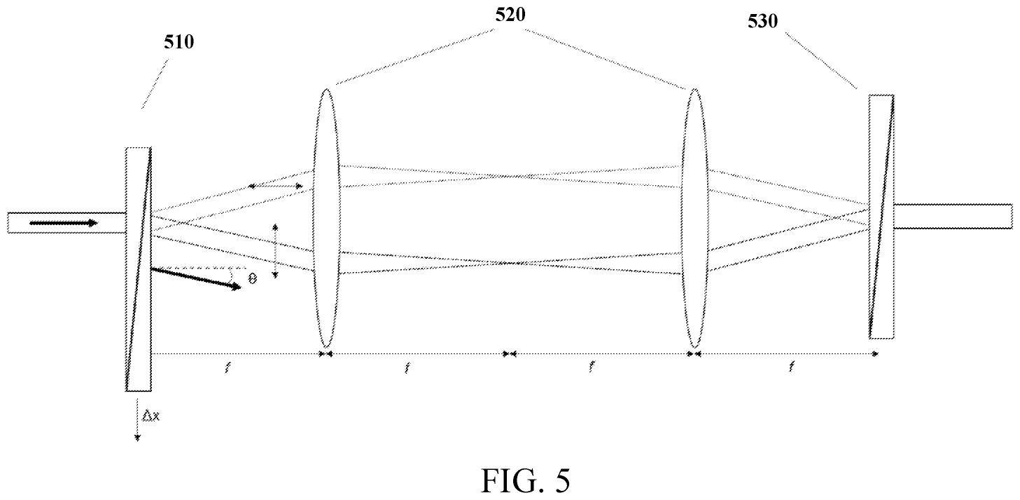

As another alternative approach, bulk polarization optics such as Wollaston prisms may be used as the beamsplitting elements. In this type of case, the polarization basis is limited to linear polarizations and the accumulated phase difference is instead dependent on the geometry of the Wollaston prism. Using a similar optics architecture as shown in FIG. 1 although without a blocker), FIG. 5 shows such an arrangement utilizing a 4F optical system 520 between Wollaston prisms 510 and 530, with the polarization basis consisting of horizontal and vertical polarizations.

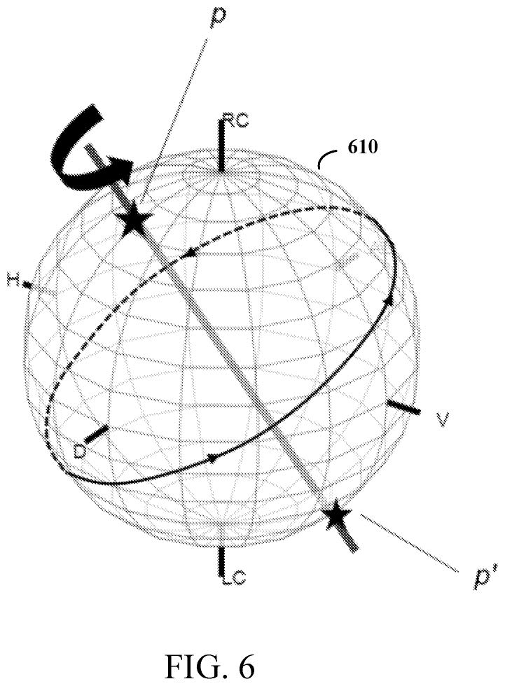

As shown in FIG. 6, the effect of the arbitrary waveplate can be expressed as a rotation of the Poincare sphere 610. The chosen polarization basis, p and p′, form the axis of rotation, and the rotation angle is determined by that differential displacement phase with 2π corresponding to a full rotation. Given a specific configuration of displacement, polarization splitting basis and input polarization, the output polarization of light traveling through the optical device can be determined by mapping the input along the appropriate rotation of the Poincare sphere.

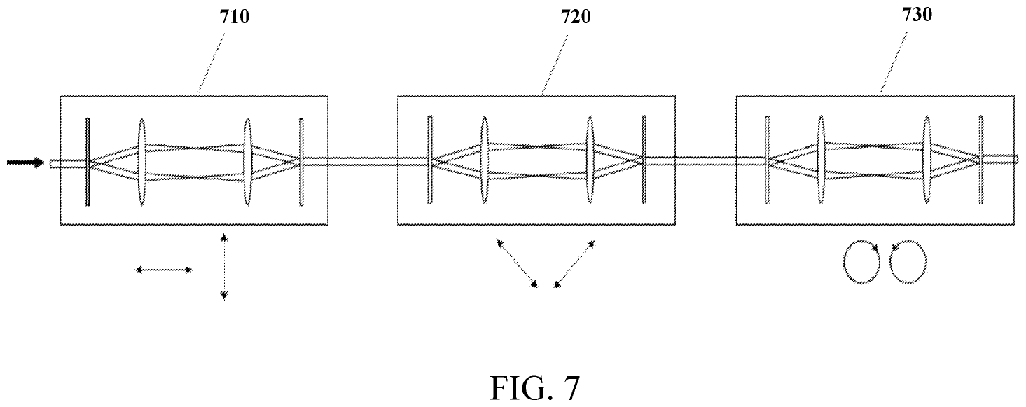

In yet further example embodiments related to the above aspects, multiple waveplate setups may be mounted in series in order to access fully arbitrary transformations of the Poincare sphere. As one example in this regard, three waveplates in series may be used to provide the necessary degrees of freedom to describe an arbitrary transformation of the Poincare sphere. An example of this type of serialized arrangement is shown in FIG. 7.

In this example, two linear waveplate modules 710, 720 and a circular waveplate module 730 are arranged in series. In the example system shown in FIG. 7, the tunable waveplate module 710 corresponds to the system shown in FIG. 1 with a basis of horizontal and vertical polarization as indicated by the directional arrows below module 710. Similarly, waveplate module 720 has a basis of 45 degree diagonal polarizations as indicated by the angularly-directed arrows below module 720 and the waveplate module 730 has a basis of right-hand and left-hand circular polarizations as indicated by the circularly-directed indicia below module 730. Alternatively, a rotating (otherwise fixed) waveplate may be used to substitute a single degree of freedom.

An alternative design with the capability for higher polarization modulation rates involves patterning the beamsplitting element continuously in a ring on the edge of a disk. The incident beam passes through the edge of the disk where the grating is patterned. The disk is then spun at high speeds relative to the second fixed element providing ultra-fast polarization modulation. Locally, the edge of the rotating disk may act as an ultra-fast continuous linear displacement, replicating the effect of translation stages without the need for resetting after movement. In this manner, at least one of the first beamsplitter and the second beamsplitter may include a patterned grating to set an optical bandwidth in which the recombined light beam is characterized.

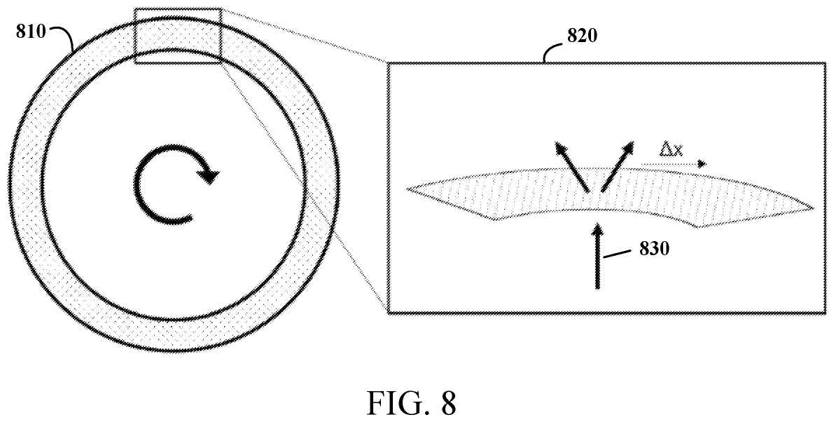

FIG. 8 shows a front view of such a spinning-disk beamsplitter 810. In an example method of use and using an exploded view via an inset 820 of the top of the spinning-disk beamsplitter 810, the incident light 830 is directed at a point on the edge of the disk, as in a direction going into the page. The inset 820 shows a cross-sectional side view of the disk with an incident light and beamsplitting action being depicted.

This ultra-fast polarization modulation can be paired with fixed polarizer in order to provide ultra-fast beam chopping. In more specific example embodiments, aspects or embodiments of this disclosure are used in systems and methodology involving or including ellipsometry, spectro-polarimetric imaging and ultra-fast laser polarization optics. Both ellipsometry and spectro-polarimetry use the measurement of the polarization of light at different wavelengths. Since there are no restrictions on the polarization of light that may need to be measured, the ability to access arbitrary polarization basis at different wavelengths may improve the speed at which these instruments can take their measurements.

For ultra-fast laser polarization optics, these short pulses are necessarily comprised of a large bandwidth. Aspects of this disclosure may be used to transform the polarization state of the pulse uniformly across all wavelengths.

Ultra-fast polarization modulation has many applications for low-noise polarimetry applications. A lock-in detector combined with the high-speed capabilities create a system with very low 1/f noise. This approach and/or structure could be used for high-performance sensors in the infrared regime.

In a particular experimental example using the structures and shapes as in FIG. 3A, a Nova NanoSEM™ scanning electron microscope is provided for imaging the arrangements of the shapes, at a magnification of 10,000 times, and as in the above-referenced U.S. Provisional patent document (Appendix B), which shows approximately 32 rows by 32 columns (with such a magnified view) of such bone-shaped devices being used to achieve this desired transition. In other examples, variation of X rows by Y columns of such shaped devices may be used, where the integers for X and Y depend on the type splitting and other system-specific goals. In one such experimental effort, a full device was made to include about 2500×2500 elements. With the pattern periodically repeating, the size of the total pattern is very dependent on the setup and application. However, the period of the repetition may be important. In the above experimental example, the repetition spacing is about 10 microns and consisting of 25 elements before the pattern repeats again in the x direction, and the y direction is uniform where every element is the same in any column. The periodicity can be adjusted to change the sensitivity of the system, for example, where shorter systems can allow for higher modulation rates if high-speed functionality is desired.

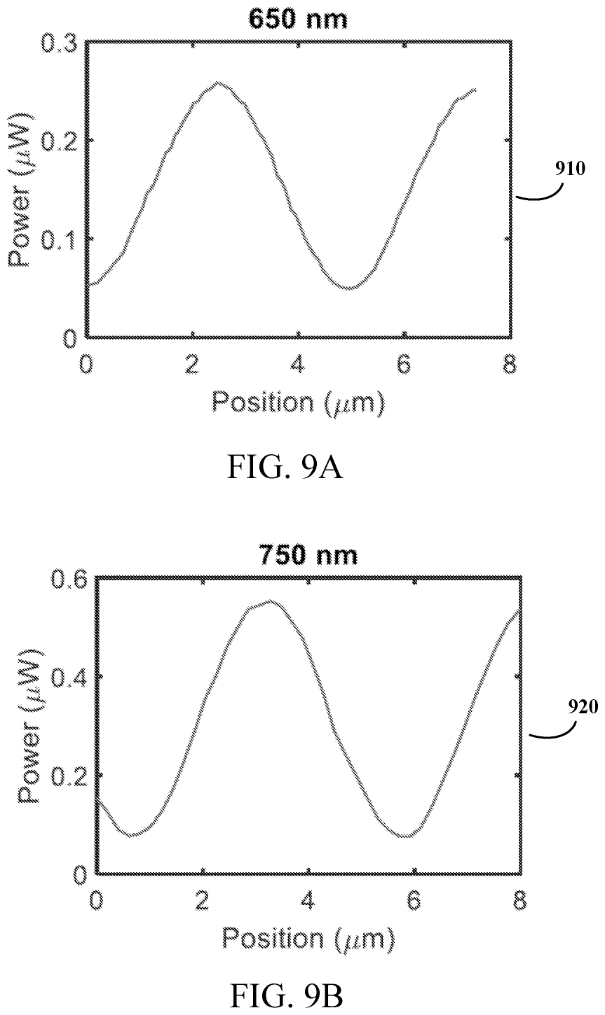

Also in accordance with certain exemplary aspects of the present disclosure, FIGS. 9A and 9B are plots 910 and 920 showing polarization modulation of an experimental sample involving two fabricated polarization gratings functioning as beamsplitting waveplates (not shown in FIGS. 9A and 9B) in a manner consistent with the above-discussed systems of FIGS. 1 and 2. More specifically, a common polarization was realized (with relative efficiency of roughly ninety percent) for incident wavelengths spanning bandwidths from 100 nm to 200 nm, and as exemplified in the plots using wavelength of 650 nm and 750 nm (850 nm not shown). For a wavelength of 650 nm, FIG. 9A shows a plot of power (the Y-axis in microWatts and through a linear polarizer) varying in sinusoidal form from about 0.06-0.28 microWatts versus relative position (in microns) as one of the fabricated gratings is moved as far as 8 microns. For a wavelength of 750 nm, FIG. 9B shows a similar power plot varying in sinusoidal form from about 0.16-0.55 microWatts versus relative position (in microns) as one of the fabricated gratings is moved as far as 8 microns. Accordingly, in these experiments a common polarization was realized (with high levels of efficiency) for incident wavelengths spanning bandwidths of (much) greater than 50 nm (e.g., 750 nm-650 nm=100 nm) and as wide as 200 nm (850 nm-650 nm), with each of these bandwidths being sufficiently wide to overlap wavelengths in each of two immediately-adjacent wavelength regimes of the light spectrum.

In connection with the above embodiments and variations thereof, a micro-electrical mechanical system (MEMS) may be used to control the movement and ultimately the related displacement phase shift. Consider a specific example embodiment, also according to the present disclosure, in which the metasurfaces and/or gratings of one or more layers are integrated to include microscaled structures of at least one shape to perform translations of light beam polarization. The MEMS is configured to control movement or set position of at least one of at least one of the first beamsplitter and the second beamsplitter, and thereby provide control over a displacement phase shift to be experienced in the multiple light beams. The MEMS may also be configured to provide self-alignment between the metasurfaces and electrical control over movement of the metasurfaces and/or gratings at microscale levels, for example, dynamically at high or low speeds (in linear, reciprocating or rotating directions) for setting or tuning the polarization state of a light beam across different wavelengths such as spanning a relatively wide bandwidth as discussed hereinabove.

According to these and other examples consistent with aspects of the present disclosure, such apparatuses and/or methods involving fast light modulation may involve optical-imaging shutter systems and/or characterizing (or identifying) certain materials, biological samples, etc. from among a plethora of possibilities.

It is recognized and appreciated that as specific examples, the above-characterized figures and discussion are provided to help illustrate certain aspects (and advantages in some instances) which may be used in the manufacture of such structures and devices. These structures and devices include the exemplary structures and devices described in connection with each of the figures as well as other devices, as each such described embodiment has one or more related aspects which may be modified and/or combined with the other such devices and examples as described hereinabove may also be found in the Appendices of the above-referenced Provisional.

The skilled artisan would also recognize various terminology as used in the present disclosure by way of their plain meaning. As examples, the Specification may describe and/or illustrates aspects useful for implementing the examples by way of various semiconductor materials/circuits which may be illustrated as or using terms such as layer, block, module, element, device, system, unit, controller, and/or other schematic-directed depictions. Such terms describe one or more materials (e.g., layer), circuitry (e.g., as in a controller or imaging system) and one or more optical elements as discussed throughout. For Example, the three waveplate modules shown in FIG. 7 would also be recognized as waveplate subsystem, forming part of an integrated optical system. As a more specific example, the term beamsplitter refers to or includes an optical device that manipulate light by dividing an incident beam into beams directed in different directions. An achromatic beamsplitter is a beamsplitter manipulating the incident beam into beams which have identical spectral power distribution or SPD. As should also be apparent the term grating refers to or includes one or more layers of material, wherein at least one of the layers is grated, and the term waveplate refers to or includes plates with transparency characteristics and with a certain amount of birefringence and as discussed in connection with the foregoing examples, they are mostly described in connection with manipulating the polarization state of light beams. Further, in connection certain examples disclosed herein, use of the term waveplate or grating (especially in connection with movement to cause a displacement phase shift) need not refer to an entire structure (e.g., all of illustrated waveplates or grating structures). It would also be appreciated that terms to exemplify orientation, such as upper/lower, left/right, top/bottom and above/below, may be used herein to refer to relative positions of elements as shown in the figures. It should also be understood that the terminology (e.g., as used in the figures) is used for notational convenience only and that in actual use the disclosed structures may be oriented different from the orientation shown in the figures.

Based upon the above discussion and illustrations, those skilled in the art will readily recognize that various modifications and changes may be made to the various embodiments without strictly following the exemplary embodiments and applications illustrated and described herein. For example, methods as exemplified in the Figures may involve steps carried out in various orders, with one or more aspects of the embodiments herein retained and/or combined with other features, or may involve fewer or more steps. Such modifications do not depart from the true spirit and scope of various aspects of the disclosure, including aspects set forth in the claims.

1. A method comprising:
using a first beamsplitter and a second beamsplitter arranged relative to one another with the first beamsplitter splitting incident light into multiple light beams, along a particular polarization basis, and with the second beamsplitter recombining and interfering with the multiple light beams to provide a recombined light beam characterized as having at least one of the following attributes: mapping between a polarization state and different wavelengths of the incident light; and a polarization tuning of the incident light.

2. The method of claim 1, wherein the polarization state is set through polarization tuning of the incident light, and the polarization tuning includes adjusting a displacement of the first beamsplitter relative to the second beamsplitter along a plane that is transverse to a direction of the incident light.

3. The method of claim 1, wherein the first beamsplitter and the second beamsplitter are constructed to correspond to each other, and the particular polarization basis corresponds to at least one set of orthogonal polarizations at equal and opposite angles; and the polarization state is set through polarization tuning of the incident light, and the polarization tuning is a function of a grating effect provided by at least one of the first beamsplitter and the second beamsplitter.

4. The method of claim 1, wherein at least one of the first and second beamsplitters is mounted and/or aligned on a stage for travelling in an optical plane orthogonal to the incident light or a beamline related to the incident light, and wherein as the first and second beamsplitters are displaced relative to each other, and the split beams experience a displacement phase shift.

5. The method of claim 1, wherein the different wavelengths are selected from within a light-spectrum wavelength band that is sufficiently wide to overlap wavelengths in each of two immediately-adjacent wavelength regimes of the light spectrum.

6. The method of claim 1, wherein the different wavelengths are selected from within a light-spectrum wavelength band that is greater than 50 nanometers and less than or equal to 200 nanometers.

7. The method of claim 1, wherein at least one of the first beamsplitter and the second beamsplitter includes a waveplate including a grating material, wherein the waveplate is characterized by or includes one or more of the following: being movable along at least one linear direction, and being rotatable or spinnable, and wherein movement of the grating material is to cause the multiple light beams to experience a displacement phase shift.

8.-9. (canceled)

10. The method of claim 1, wherein at least one of the first beamsplitter and the second beamsplitter is characterized by or includes a grating which includes one or more of the following: shaped materials of a free-form design; freeform geometries designed for broadband operation; and a liquid crystal material in one or more liquid crystals designed for broadband operation.

11. The method of claim 1, further including imaging the first beamsplitter and the second beamsplitter onto one another by using a 4F optical system located between the first beamsplitter and the second beamsplitter, and wherein at least one of the first beamsplitter and the second beamsplitter includes a patterned grating to set an optical bandwidth in which the recombined light beam is characterized as having said at least one of the attributes.

12. The method of claim 1, further including using a 0-order or higher order blocker to block light attributes in a light path between the first beamsplitter and the second beamsplitter.

13. The method of claim 1, further including using a 4F optical system to perform filtering in the Fourier plane to affect a light path between the first beamsplitter and the second beamsplitter by one or more of the following: blocking undesired diffraction orders; balancing power in desired diffraction orders; operating for selectivity; and obtaining measurements of light in path between the first beamsplitter and the second beamsplitter.

14. (canceled)

15. The method of claim 1, further including using multiple waveplate modules arranged in series to provide manipulation of a beam of the incident light, wherein one of the multiple waveplate module is a tunable waveplate module that includes the first beamsplitter and the second beamsplitter, and at least one other of the multiple waveplate modules has a polarization basis different from the particular polarization basis of the first beamsplitter.

16. The method of claim 1, further including at least one of the following steps: using multiple waveplate modules arranged in series to provide manipulation of a beam of the incident light for accessing a transformation of a Poincare sphere; and providing polarization modulation by rotating or spinning at least one of the first beamsplitter and the second beamsplitter.

17.-20. (canceled)

21. An apparatus comprising:
a first beamsplitter to split incident light into multiple light beams along a particular polarization basis; and
a second beamsplitter coupled relative to the first beamsplitter to recombine and interfere with the multiple light beams and to provide a recombined light beam characterized as having at least one of the following attributes: a polarization state which maps to different wavelengths of the incident light; and a polarization tuning, of the incident light, that is characterized as being at least one of: a displacement of the first beamsplitter relative to the second beamsplitter along a plane that is transverse to a direction of the incident light, and a function of a grating effect provided by at least one of the first beamsplitter and the second beamsplitter.

22. The apparatus of claim 21, wherein the first beamsplitter and the second beamsplitter are configured for tuning the polarization state of the incident light achromatically.

23. The apparatus of claim 21, further including a micro-electrical mechanical system (MEMS) having metasurfaces and/or gratings which are integrated to include microscaled structures of one common or multiple shapes to perform transformation of light beam polarization, and wherein the MEMS is configured to control movement or set position of at least one of the first beamsplitter and the second beamsplitter, and therein provide control over a displacement phase shift to be manifested in the multiple light beams.

24. The apparatus of claim 21, wherein the polarization tuning is characterized as being: a displacement of the first beamsplitter relative to the second beamsplitter.

25. The apparatus of claim 21, wherein at least one of the first beamsplitter and the second beamsplitter includes a grating characterized by one or more of the following: materials of an irregular shape; one or more metals materials; one or more dielectric materials; and a liquid crystal material.

26. The apparatus of claim 21, further including using a 0-order or higher order blocker to block light attributes in a light path between the first beamsplitter and the second beamsplitter.

27. An apparatus for use in an optical system having a first beamsplitter to split incident light into multiple light beams along a particular polarization basis to recombine multiple light beams, the apparatus comprising:
a second beamsplitter coupled and arranged relative to the first beamsplitter such that one of the first and second beamsplitters is to split incident light into multiple light beams along a particular polarization basis and the other of the first and second beamsplitters is to recombine and interfere with the multiple light beams and to provide a recombined light beam characterized as having at least one of the following attributes:
a polarization state which maps to different wavelengths of the incident light; and a polarization tuning of the incident light, wherein the first and second beamsplitters are configured relative to the other of the first and second beamsplitters based on a movement in of at least one of the first and second beamsplitters in an orthogonal direction, relative to a plane along which at least one of the multiple light beams travels, to cause a displacement phase shift to be experienced in the multiple light beams.

28. (canceled)
